(19) United States
(12) Patent Application Publication
(10) Pub. No.: US 2007/0184800 A1
(43) Pub. Date: Aug. 9, 2007

(54) Radio network for protecting electronic devices from electromagnetic radiation of a mobile station

(75) Inventors: Bernhard Vogel, Gossweinstein (DE); Matthias Wedel, Nurnberg (DE)

Correspondence Address: Brinks Hofer Gilson & Lione, 455 No Cityfront Plaza, Suite 3600, Chicago, IL, 60611-5599, US

(73) Assignee: SIEMENS AKTIENGESELLSCHAFT, Munich (DE)

(21) Appl. No.: 10/568,193

(22) PCT Filed: Jul. 21, 2004
(86) PCT No.: PCT/EP04/08163

§ 371 Date: Dec. 18, 2006

(30) Foreign Application Priority Data
Aug. 11, 2003 (DE) 103 36 733.0

(51) Int. Cl. H01Q 11/12; H04B 1/16; H04M 1/00

(52) U.S. Cl. 455/217; 455/117; 455/575.5

(57) ABSTRACT

A radio network comprises a first device (2) with a transmitter (3), whereby a second device (4) is to be protected from electromagnetic radiation of the transmitter (3) and at least one of the devices (2, 4) is mobile. One of the devices (2, 4) has a wireless interrogation system (6) that interacts with a reflecting device (5) of the other device (4, 2), and one of the devices (2, 4) can be switched according to the distance from the other device, this distance being detected by means of the interrogation system (6) and the reflecting device (5), between a normal operating mode (N2, N4) and a special operating mode (S2, S4) provided for comparatively short distances. The operating mode of the device comprising the transmitter (3) is variable. Optionally, the transmitter (3) can have a transmit power that is dependent on the operating mode.

### TECHNICAL FIELD

The invention relates to a radio network, particularly for use in hospitals, and to a method for operating a radio network.

Wireless communications networks, and especially radio networks known by the name WLAN (wireless local area network), are often used in buildings.

Restrictions in the use of such radio networks often arise because of devices that are sensitive to electromagnetic radiation, especially in hospitals. In areas where devices, such as respirators, which might be affected by electromagnetic radiation are located, radio networks are therefore typically not used.

The object of the invention is to achieve additional fields of use for radio networks in areas where devices that are sensitive to electromagnetic radiation are located, especially in hospitals.

This object is attained according to the invention by a radio network having the characteristics of claim 1 and by a method for operating a radio network having the characteristics of claim 6. Here a first device is a device of the radio network that has a transmitter, while a second device is a device that is to be protected against the electromagnetic radiation of the transmitter. One of the two devices has a wireless interrogation system, which cooperates with a reflecting device, in particular a transponder, of the other device. The interrogation system, together with the reflecting device, forms a contactless detection system, which furnishes the first and/or second device with at least approximate information about the distance between the two devices. Preferably, the device in the radio network that has the transmitter is at the same time equipped with the interrogation system as well, while the second device that is sensitive to the electromagnetic radiation of the radio network has the reflecting device, preferably embodied as a transponder. In this configuration, the electromagnetic load on the second device, which is threatened by electromagnetic radiation, and in particular is a medical device, can be monitored and controlled overall. Depending on the type and size of the devices, among other factors, however, the second device, to be protected against the radiation of the radio network, may also have a transceiver unit of a contactless interrogation system, while the first device, forming part of the radio network, has a corresponding reflecting device.

Depending on the distance between the devices, measured by means of the contactless proximity measuring system, a switchover is made between two different operating modes, namely a normal operating mode and a special operating mode, the latter intended for shorter distances, of at least one of the devices. The term “distance” should be understood to mean a distance signal that is dependent on the distance and is measurable by the measurement system. In addition to the geometric spacing between the devices, any possible influence of the radiation, originating at the transmitter, because of radiation-absorbing or -reflecting elements is taken into account. In other words, what is decisive for the switchover between the various operating modes is the degree of attenuation of the electromagnetic radiation, originating at the transmitter, at the location of the second device.

In a first embodiment, the transmit power of the transmitter of the first device is set differently in the various transmission modes. The transmit power can be reduced in stages or continuously here. In the event of impermissibly high electromagnetic field intensities in the area of the second device, the possibility also exists of switching off the transmitter automatically. A threat to the second device from the transmission unit of the contactless interrogation system, conversely, need not as a rule be assumed. Accordingly, both in embodiments in which the interrogation system is integrated with the first device, as is preferably provided, and in embodiments in which the first device includes only the reflecting device, the interrogation system is typically operated at constant operating parameters, and in particular a constant transmission power. If a threat to the second device by the radiation occurring in operation of the interrogation system cannot be precluded, then in a departure from the above, it is also possible to vary the operating parameters of the interrogation system as a function of the measured distance between the two devices.

In addition or as alternative to varying the transmit power, in a preferred refinement, the outputting of a warning report by one of the devices as a function of the operating mode is provided. Independently of or in addition to a generated warning report, the possibility of an automatic shutoff of the second device that is to be protected can be provided for. Preferably, the device that is threatened by the electromagnetic radiation automatically adapts its operation to the threat. In an especially preferred embodiment, if an approach between the two devices is detected by the contactless proximity measuring system, a switchover of the operating mode of both the first, threatened device and the second, threatened device is provided, and stopping the operation is also included as a special case of an operating mode switchover.

One exemplary embodiment of the invention is described in further detail below in conjunction with a drawing. The sole drawing FIGURE shows a radio network in the form of a schematic layout plan.

A radio network 1, installed for instance in a hospital, includes, in addition to a number of fixed stations, not shown, a typically mobile device 2, which has a transmitter 3. A second device 4, for instance a respirator, which is not part of the radio network 1, is potentially threatened by the radiation, originating at the transmitter 3, of the first device 2, such as a mobile phone or a tablet computer.

The second device 4 has at least one and preferably a plurality of reflecting devices 5, in the form of transponders (TAGs), which are for instance glued in the form of labels to the second device 4. Alternative, reflecting devices 5, for instance in the form of small tubes, may be secured to the second device 4. Cooperating with the reflecting devices 5, in a manner known per se, for instance from German Patent DE 197 03 823 C1, is an interrogation system 6 of the first device 2, this system including a transceiver unit. The transmitter, not identified by reference numeral, of the interrogation system 6 is not necessarily part of the radio network 1. The radiation originating in the transmitter of the interrogation system 6 is represented symbolically by concentric circles in the drawing and defines a detection range 7 within which the interrogation system 6 can detect the presence of a reflecting device 5. The detection range 7 typically extends over a distance on the order of magnitude of 1 m. The result is a safety zone 8 surrounding the second device 4 and drawn in dashed lines. If the first device 2 is moved into the safety zone 8, then the first device 2 automatically switches over from a first operating mode, that is, the normal operating mode N2, to a second operating mode, the special operating mode S2.

The operating parameters of the special operating mode S2 are adjustable. It is preferably provided that the transmitter 3 of the first device 2, in the safety zone 8, reduces the transmission power or stops the operation partially or completely, in order to preclude a threat to the second device 4. It is also provided that the first device 8, upon being positioned in the safety zone 8, outputs a warning report, which for instance warns against operating the first device 2 in the vicinity of the second device 4 or calls for removing the first device 2 out of the safety zone 8.

As an alternative to the exemplary embodiment shown, the threatened second device 4 can also have the interrogation system 6, while the first device 2 that includes the transmitter 3 has at least one reflecting device (TAG) 6. In that case, in an especially simple way, the second device 4, which reads out the interrogation system 6, can output a warning report upon the approach of the first device 2. An especially simple possibility is also created for stopping the operation of the second device 4 in response to the threat from the electromagnetic radiation originating in the first device 2, by means of a switchover from a normal operating mode N4 to a special operating mode S4, for instance an emergency operation program. The provision of a reflecting device 6 on the first device 2 furthermore has the advantage that permanently equipping the first device 2 with a wireless interrogation system is unnecessary; instead, as needed, for instance solely while in a threatened area such as a hospital, the reflecting device 5 can be secured to the first device 2, for instance glued to it or clipped to it.

1-10. (canceled)

11. A protective device for protecting a second device from the electromagnetic radiation of a first device that is part of a radio network the first device having a transmitter that emits the electromagnetic radiation, wherein at least one of the first device or the second device can be changed in location, the protective device comprising;
a wireless interrogation system associated with one of the first device or the second device, which cooperates with a reflecting device associated with the other of the first device or the second device so as to determine an electromagnetic field strength at the one of the first device or the second device having the wireless interrogation system or a distance between the first device and the second device,
wherein the protective device is switched between a normal operating mode and a special operating mode when the electromagnetic field strength is above a threshold, or the distance is less than a distance threshold.

12. The protective device as in claim 11, wherein the transmitter has a transmit power that is dependent on the operating mode.

13. The protective device as in claim 11, wherein the special operating mode of one of the devices includes an output of a warning report.

14. The protective device as in claim 13, wherein the output of the warning report by the first device includes a warning against a closer approach to the second device or an indication of a required greater distance from the second device.

15. The protective device as in claim 13, wherein the warning report output by the second device includes a warning that the second device may be harmed by the first device.

16. A method for protecting a second device from electromagnetic radiation emitted by of a first device that is part of a radio network, the first device having a transmitter that emits the electromagnetic radiation, the method comprising:
providing a contactless proximity measuring system having a transponder on one of the first device or the second device, and a reflecting device on the other of the one of the first device or the second device;
determining a distance between the first device and the second device, or the second device and the first device; and
switching between a normal operating mode and a special operating mode of one of the devices when a distance between the devices is a short distance,
wherein, the transmitter is operated at reduced transmission power in the special operating mode.

17. The method as in claim 16, wherein upon switchover to the special operating mode, the operation of the transmitter is terminated.

18. The protective device as in claim 12, wherein the special operating mode of one of the devices includes an output of a warning report.

19. The protective device as in claim 18, wherein the output of the warning report by the first device includes a warning against a closer approach to the second device or an indication of a required greater distance from the second device.

20. The protective device as in claim 19, wherein the warning report output by the second device includes a warning that the second device may be harmed by the first device.
